(19) United States
(12) Patent Application Publication
(10) Pub. No.: US 2006/0285769 A1
(43) Pub. Date: Dec. 21, 2006

(54) Method, apparatus, and medium for removing shading of image

(75) Inventors: Haitao Wang, Beijing (CN); Seokcheol Kee, Seoul (KR); Jiali Zhao, Beijing (CN); Haibing Ren, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/455,772

(22) Filed: Jun. 20, 2006

(30) Foreign Application Priority Data
Jun. 20, 2005 (KR) 10-2005-0053155

(51) Int. Cl. G06K 9/40

(52) U.S. Cl. 382/274

(57) ABSTRACT

A method, apparatus, and medium for removing shading of an image are provided. The method of removing shading of an image includes: smoothing an input image; performing a gradient operation for the input image; performing normalization using the smoothed image and the images for which the gradient operation is performed; and integrating the normalized images. The apparatus for removing shading of an image includes: a smoothing unit smoothing an input image using a predetermined smoothing kernel; a gradient operation unit performing a gradient operation for the input image using a predetermined gradient operator; a normalization unit performing normalization using the smoothed image and the images for which the gradient operation is performed; and an image integration unit integrating the normalized images. According to the method, apparatus, and medium, by defining a face image model analysis and intrinsic and extrinsic factors and setting up a rational assumption, an integral normalized gradient image not sensitive to illumination is provided. Also, by employing an anisotropic diffusion method, a moire phenomenon in an edge region of an image can be avoided.

### CROSS-REFERENCE TO RELATED APPLICATIONS

This application claims the benefit of Korean Patent Application No.10-2005-0053155, filed on Jun. 20, 2005, in the Korean Intellectual Property Office, the disclosure of which is incorporated herein in its entirety by reference.

### BACKGROUND OF THE INVENTION

1. Field of the Invention

The present invention relates to image recognition and verification, and more particularly, to a method, apparatus, and medium for removing shading of an image.

2. Description of the Related Art

Illumination is one of the major elements having a great influence on the performance of a face recognition system or face recognition method. Examples of face recognition systems or methods include a principal component analysis (PCA), a linear discriminant analysis, and a Garbor method. These methods or systems are mostly appearance-based ones though other features should be extracted. However, even if the direction of illumination changes a little, the appearance of a face image can be greatly changed. According to a recent report on face recognition grand challenge (FRGC) version 2.0 (v2.0), under a controlled scenario (experiment 1), the best verification rate at FAR=0.001 is about 98%. (FAR refers to false acceptance rate.) Here, the scenario strictly limits the illumination condition to frontal direction variation. Meanwhile, under an uncontrolled environment (experiment 4), the verification rate at FAR=0.001 is about 76%. The major difference of the two experiments is caused by illumination as shown in FIG. 1.

In order to solve this problem, many algorithms have been suggested recently and these are categorized broadly into two approaches, that is, a model based approach and a signal based approach. The model based approach, which uses models such as an illumination cone, spherical harmonic, and a quotient image, compensates for illumination change by using the advantages of a 3-dimensional or 2-dimensional model. However, generalization of a 3-dimensional or 2-dimensional model is not easy and it is difficult to actually apply the models.

Meanwhile, a Reintex method by R. Gross and V. Bajovic and a self-quotient image (SQI) method by H. Wang et al. belong to the signal based approach. These methods are simple and generic, and do not need training images. However, the performances of these methods are not excellent.

### SUMMARY OF THE INVENTION

Additional aspects, features, and/or advantages of the invention will be set forth in part in the description which follows and, in part, will be apparent from the description, or may be learned by practice of the invention.

The present invention provides a method, apparatus, and medium for removing shading of an image enabling simple and generalized illumination compensation and high performance in image recognition.

According to an aspect of the present invention, there is provided a method of removing shading of an image including: smoothing an input image; performing a gradient operation for the input image; performing normalization using the smoothed image and the images for which the gradient operation is performed; and integrating the normalized images.

The input image may be described as a Lambertian model as the following equation:
I=ρn^{T}·s
where I denotes an input image, ρ denotes texture, n denotes a 3-dimensional shape, and s denotes illumination.

The smoothing of the input image may be performed by performing an operation of the input image and a predetermined smoothing kernel according to the following equation in relation to the shading part n^{T}·s of the above equation:
Ŵ=I*G
where Ŵ denotes a smoothed image, I denotes an input image, and G denotes a smoothing kernel.

The gradient operation of the input image may be to obtain a gradient map according to a Sobel operator.

The gradient operation of the input image may be performed according to the following equation:
∇I=∇(ρn^{T}·s)≈(∇ρ)n^{T}·s=(∇ρ)W
where W denotes a scaling factor by shading n^{T}·s

The normalized image may be obtained by dividing the smoothed image in relation to images for which gradient operation is performed:

$$N = \frac{∇ I}{\hat{W}} \approx \frac{( ∇ ρ ) W}{\hat{W}} \approx ∇ ρ$$

Assuming that ∇_{y}I_{i,j}=I_{i,j}−I_{i-1,j} and ∇ₓI_{i,j=I}_{i,j}−I_{i,j-1}, the integrating of the normalized images may be performed by the following equations:

$${∇}_{N} I = {I}_{i - 1 , j} - {I}_{i , j} = - {∇}_{y} {I}_{i , j}$$

$${∇}_{S} I = {I}_{i + 1 , j} - {I}_{i , j} = {∇}_{y} {I}_{i + 1 , j}$$

$${∇}_{W} I = {I}_{i , j - 1} - {I}_{i , j} = {∇}_{x} {I}_{i , j}$$

$${∇}_{E} I = {I}_{i , j + 1} - {I}_{i , j} = {∇}_{x} {I}_{i + 1 , j}$$

$${I}_{i , j}^{t} = {I}_{i , j}^{t - 1} + λ [ \begin{matrix}{C}_{N} ( {I}_{i , j}^{t - 1} + {∇}_{N} I ) + {C}_{S} ( {I}_{i , j}^{t - 1} + {∇}_{S} I ) + \\ {C}_{W} ( {I}_{i , j}^{t - 1} + {∇}_{W} I ) + {C}_{E} ( {I}_{i , j}^{t - 1} + {∇}_{E} I )\end{matrix} ]$$

$${C}_{K} = \frac{1}{1 + ‖ {I}_{i , j}^{t - 1} + {∇}_{K} I ‖ / G}$$

where Kε{N,S,W,E}, I^{o}=0, G denotes a scaling factor, and λ denotes an updating control constant.

According to another aspect of the present invention, there is provided an apparatus for removing shading of an image including: a smoothing unit smoothing an input image using a predetermined smoothing kernel; a gradient operation unit performing a gradient operation for the input image using a predetermined gradient operator; a normalization unit performing normalization using the smoothed image and the images for which the gradient operation is performed; and an image integration unit integrating the normalized images.

According to still another aspect of the present invention, there is provided a computer readable recording medium having embodied thereon a computer program for executing the methods in a computer.

According to an aspect of the present invention, there is provided a method of removing shading of an image including smoothing an input image to provide a smoothed input image; performing a gradient operation on the input image to provide an intermediate image; dividing intermediate image into a plurality of smoothed images; performing normalization on the smoothed images using the smoothed input image to provide normalized images; and integrating the normalized images.

In another aspect of the present invention, there is provided at least one computer readable medium storing executable instructions that control at least one processor to perform the methods of the present invention.

According to an aspect of the present invention, there is provided an apparatus for removing shading of an image including a smoothing unit which smoothes an input image to provide a smoothed input image; a gradient operation unit which performs a gradient operation for the input image using a predetermined gradient operator to provide an intermediate image; a normalization unit which divides intermediate image into a plurality of smoothed images and performs normalization on the smoothed images using the smoothed input image; and an image integration unit integrating the normalized images.

### BRIEF DESCRIPTION OF THE DRAWINGS

These and/or other aspects, features, and advantages of the invention will become apparent and more readily appreciated from the following description of the embodiments, taken in conjunction with the accompanying drawings of which:

FIG. 1 illustrates the difference of illuminations in two experiments;

FIG. 2 is a block diagram of an apparatus for removing shading of an image according to an exemplary embodiment of the present invention;

FIG. 3 illustrates an image described by illumination, shape and texture;

FIGS. 4A and 4B illustrate sample images with respect to illumination change;

FIGS. 5A and 5B illustrate an edge in a face image sensitive to illumination;

FIG. 6 is a flowchart of a method of removing shading of an image according to an exemplary embodiment of the present invention;

FIG. 7A illustrates gradient maps ∇_{y}I and ∇ₓI in the horizontal direction and in the vertical direction of an input image according to an exemplary embodiment of the present invention;

FIG. 7B illustrates gradient maps Nₓ, and N_{y} normalized with respect to gradient maps according to an exemplary embodiment of the present invention;

FIG. 7C illustrates an image obtained by integrating normalized gradient maps Nₓ, and N_{y} according to an exemplary embodiment of the present invention;

FIG. 8 illustrates 4 neighbor pixels of an image used in equation 6 according to an exemplary embodiment of the present invention;

FIG. 9 illustrates an image restored by an isotropic method according to an exemplary embodiment of the present invention;

FIG. 10 illustrates an image restored by an anisotropic method according to an exemplary embodiment of the present invention;

FIG. 11 illustrates input images and effects of illumination normalization for the images;

FIG. 12 illustrates verification results in relation to the Gabor features of original images, SQI, and an integral normalized gradient image (INGI);

FIG. 13 illustrates verification results in relation to the PCA features of original images, SQI, and INGI;

FIG. 14A illustrates the verification result of mask I in relation to a false rejection rate (FRR), a false acceptance rate (FAR), and an equal error rate (EER);

FIG. 14B illustrates the receiver operating characteristics (ROC) curve by a biometric experimentation environment (BEE) of mask I;

FIG. 15A illustrates the verification result of mask II in relation to FRR, FAR, and EER;

FIG. 15B illustrates the ROC curve by a biometric experimentation environment (BEE) of mask II;

FIG. 16A illustrates the verification result of mask III in relation to FRR, FAR, and EER; and

FIG. 16B illustrates the ROC curve by a biometric experimentation environment (BEE) of mask III.

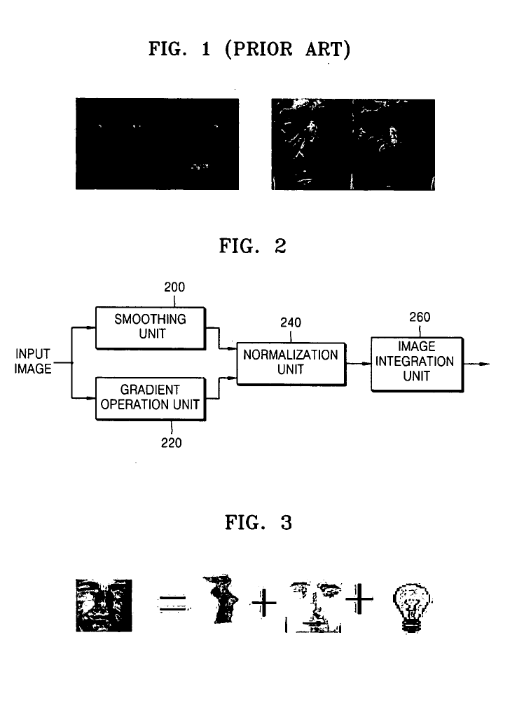

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

FIG. 2 is a block diagram of an apparatus for removing shading of an image according to an exemplary embodiment of the present invention. The apparatus includes a smoothing unit 200, a gradient operation unit 220, a normalization unit 240, and an image integration unit 260.

The smoothing unit 200 smoothes an input image by using a predetermined smoothing kernel. The gradient operation unit 220 performs a gradient operation for the input image by using a predetermined gradient operator. The normalization unit 240 normalizes the smoothed image and the images for which gradient operations are performed. The image integration unit 260 integrates the normalized images.

First, the input image will now be explained in detail. A 3-dimensional object image can be described by a Lambertian model.
I=ρn^{T}·s (1)

As shown in FIG. 3, the grayscale of a 3-dimensional object image can be divided into 3 elements, that is, texture ρ, a 3-dimensional shape n and illumination s according to the equation 1.

Excluding the nose region, most of a human face is relatively flat and continuous. Also, even though faces of even different persons are very similar to a 3-dimensional shape n^{T}. This characteristic can be known from an empirical fact that warping of the texture of another person into a general face shape does not have a great effect on the identity of each individual. A quotient image method uses this advantage in order to extract a feature that does not change by illumination. Accordingly, texture information plays an important role in face recognition.

According to the equation 1, in an image model, n^{T}·s is a part sensitive to illumination.

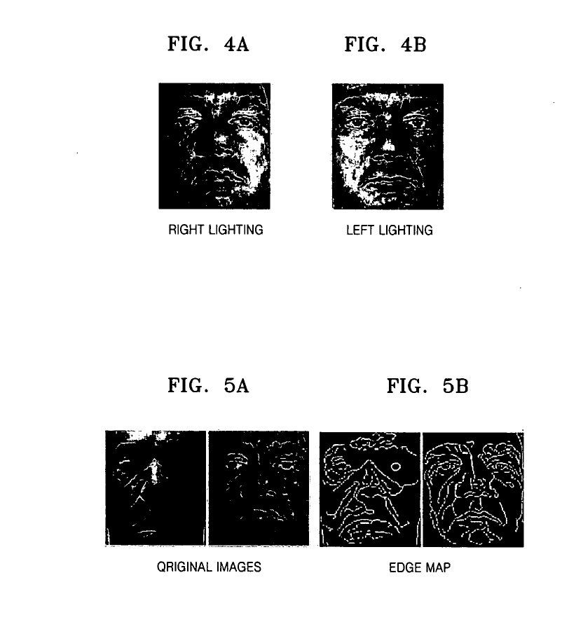

In face recognition grand challenge (FRGC) v2.0 target images, even if there is a very small change in the direction of illumination, clear image changes appear as shown in FIG. 4.

When ρ is defined as an intrinsic factor and , n^{T}·s is defined as an extrinsic factor, the intrinsic factor is free from illumination and shows identity.

Meanwhile, the extrinsic factor is very sensitive to illumination change and only partial identity is included in the 3-dimensional shape n^{T}. Furthermore, the illumination problem is the well-known ill-posed problem. Without an additional assumption or constraint, any analytical solution cannot be derived from a 2-dimensional input image.

According to the previous approaches, for example, the illumination cone and spherical harmonic method, the 3-dimensional shape n^{T} can be obtained directly with a known parameter or can be estimated by training data. However, in many actual systems, these requirements cannot be satisfied. Even though a quotient image algorithm does not need 3-dimensional information, its application scenario is limited to a point lighting source.

Definitions of intrinsic and extrinsic factors are based on a Lambertian model with a point lighting source. However, these definitions can be expanded to a lighting source of another form by combination of point lighting sources as shown in the following equation 2:

$$I = ρ {\sum }_{t} {n}^{T} \cdot {S}_{i} \qquad ( 2 )$$

In short, improving the intrinsic factor and restricting the extrinsic factor in an input image enables generation of an image not sensitive to illumination. This is a basic idea of the present invention.

The intrinsic factor mainly includes skin texture and has sharp spatial changes. The extrinsic factor, that is, the shading part, includes illumination and a 3-dimensional shape. Excluding the nostrils and open mouth, the shading is continuous and has a relatively gentle spatial change. Accordingly, the following assumptions can be made:
(1) An intrinsic factor exists in a high spatial frequency domain.
(2) An extrinsic factor exists in a low spatial frequency domain.

A direct application example of these assumptions is a high pass filter.

However, this kind of filter is vulnerable to illumination change as shown in FIG. 5. In addition, this type of operation removes a useful intrinsic factor. In fact, this result can be inferred from the equation 1 and the two assumptions.

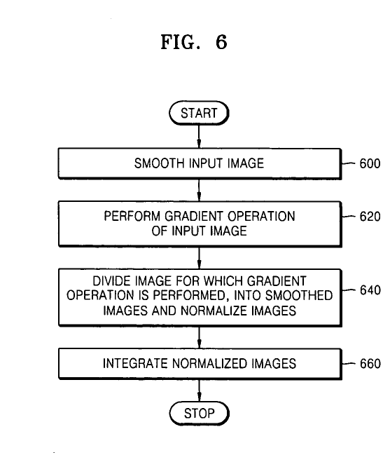

FIG. 6 is a flowchart of a method of removing shading of an image according to an exemplary embodiment of the present invention. The operations of a method and apparatus for removing shading of an image according to an exemplary embodiment of the present invention will now be explained with reference to FIG. 6.

With an input image, the smoothing unit 200 performs smoothing in operation 600. The smoothing is performed by performing an operation of the input image and a predetermined smoothing kernel according to the following equation 4 in relation to the shading part n^{T}·s of the equation 1. The Retinex method and the SQI method assume similar smoothing features for illumination. These methods use smoothed images for evaluation of an extrinsic part. Though an identical process, an extrinsic factor is predicted.
Ŵ=I*G (4)
where Ŵ denotes a smoothed image, I denotes an input image, and G denotes a smoothing kernel.

Also, with the input image, a gradient operation is performed in the gradient operation unit 220 in operation 620. The gradient operation can be expressed as the following equation 3:
∇I=∇(ρn^{T}·s)≈(∇ρ)n^{T}·s=(∇ρ)W (3)
where W denotes a scaling factor by shading n^{T}·s. The gradient operation is performed by obtaining a gradient map by using a Sobel operator.

After the input image is smoothed and the gradient operation is performed, the image for which the gradient operation is performed is divided by smoothed images and normalized in operation 640. The normalization is to overcome the sensitivity to illumination and the gradient map is normalized according to the following equation 5:

$$N = \frac{∇ I}{\hat{W}} \approx \frac{( ∇ ρ ) W}{\hat{W}} \approx ∇ ρ \qquad ( 5 )$$

Since Ŵ is a smoothed image acceptable by estimation of an extrinsic factor, an illumination image is normalized and then removed from the gradient map.

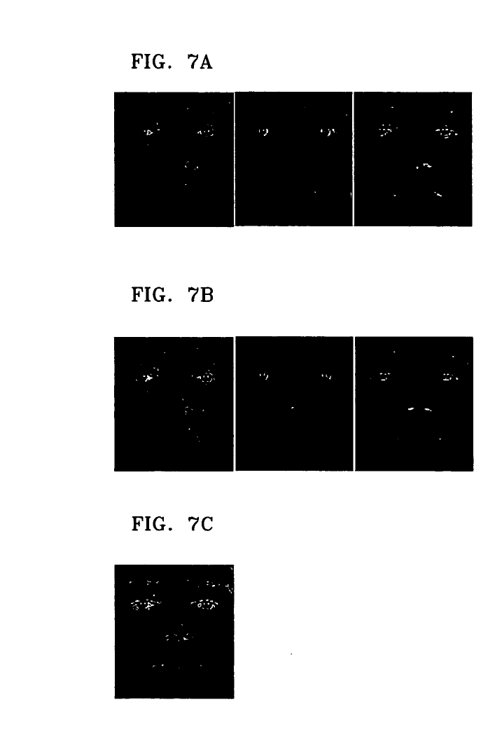

The normalized images are integrated in the image integration unit 260 in operation 660. The image integration will now be explained. After the normalization, texture information in a normalized image N is still unclear and the image has much noise due to the high pass gradient operation. In order to restore the texture and remove the noise, the normalized gradient is integrated and an integral normalized gradient image is obtained as shown in FIGS. 7A through 7C.

FIG. 7A illustrates gradient maps ∇_{y}I and ∇ₓI in the horizontal direction and in the vertical direction of an input image according to an exemplary embodiment of the present invention. FIG. 7B illustrates gradient maps Nₓ, and N_{y} normalized with respect to the gradient maps according to an exemplary embodiment of the present invention. FIG. 7C illustrates an image obtained by integrating the normalized gradient maps Nₓ, and N_{y} according to an exemplary embodiment of the present invention. There are two reasons for the integration operation. First, by integrating the gradient images, the texture can be restored. Secondly, after the division operation of the equation 5 is performed, the noise information becomes much stronger and the integration operation can smooth the image.

This process can be briefed as the following three stages: (1) A gradient map is obtained by a Sobel operator. (2) The image is smoothed and a normalized gradient image is calculated. (3) Normalized gradient maps are integrated.

The gradient map integration is to restore a grayscale image from gradient maps. Actually, if an initial grayscale value of one point in an image is given, the grayscale of any one point can be estimated by simply adding values. However, the result can vary due to a different integral road.

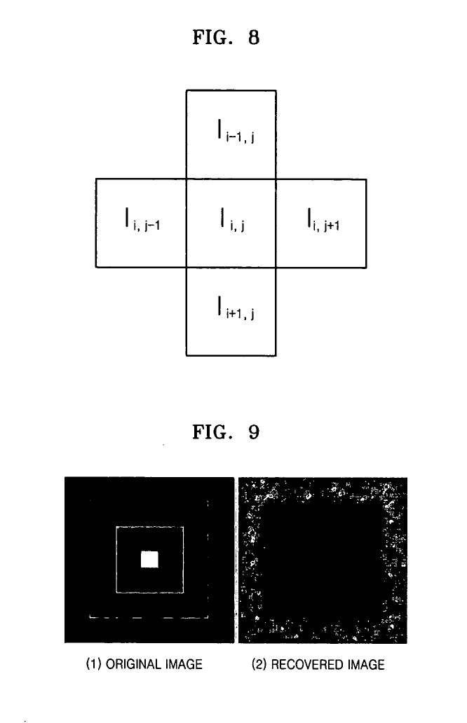

As an alternative method, there is a repetitive diffusion method as the following equation 6:

$${I}_{i , j}^{t} = \frac{1}{4} [ \begin{matrix}( {I}_{i , j}^{t - 1} + {∇}_{N} I ) + ( {I}_{i , j}^{t - 1} + {∇}_{S} I ) + \\ ( {I}_{i , j}^{t - 1} + {∇}_{W} I ) + ( {I}_{i , j}^{t - 1} + {∇}_{E} I )\end{matrix} ] \qquad ( 6 )$$

where
∇_{N}I=I_{i-1,j}−I_{i,j}
∇ₛI=I_{i+1,j}−I_{i,j}
∇_{W}I=I_{i,j-1}−I_{i,j}
∇_{E}I=I_{i,j+1}−I_{i,j,}
and usually I^{o}=0. FIG. 8 illustrates 4 neighbor pixels of an image used in the equation 6 according to an exemplary embodiment of the present invention. However, this isotropic method has one shortcoming that an image shows a moiré phenomenon in an edge region as shown in FIG. 9. In order to overcome this shortcoming, the present invention employs an anisotropic approach.

Assuming the gradient of an image is ∇_{y}I_{i,j}=I_{i,j}−I_{i-1,j} and ∇ₓI_{i,j}=I_{i,j}−I_{i,j-1}, the gradients can be obtained as the following equations 7 and 8:

$$\begin{matrix}{∇}_{N} I = {I}_{i - 1 , j} - {I}_{i , j} = - {∇}_{y} {I}_{i , j} \\ {∇}_{S} I = {I}_{i + 1 , j} - {I}_{i , j} = {∇}_{y} {I}_{i + 1 , j} \\ {∇}_{W} I = {I}_{i , j - 1} - {I}_{i , j} = {∇}_{x} {I}_{i , j} \\ {∇}_{E} I = {I}_{i , j + 1} - {I}_{i , j} = {∇}_{x} {I}_{i + 1 , j} & ( 7 ) \\ {I}_{i , j}^{t} = {I}_{i , j}^{t - 1} + λ [ \begin{matrix}{C}_{N} ( {I}_{i , j}^{t - 1} + {∇}_{N} I ) + {C}_{S} ( {I}_{i , j}^{t - 1} + {∇}_{S} I ) + \\ {C}_{W} ( {I}_{i , j}^{t - 1} + {∇}_{W} I ) + {C}_{E} ( {I}_{i , j}^{t - 1} + {∇}_{E} I )\end{matrix} ] \\ {C}_{K} = \frac{1}{1 + ‖ {I}_{i , j}^{t - 1} + {∇}_{K} I ‖ / G} & ( 8 )\end{matrix}$$

where Kε{N,S,W,E}, I^{o}=0, G denotes a scaling factor, and λ denotes an updating speed. If λ is too big, a stable result cannot be obtained and in the experiment of the present invention, it is set that λ=0.25.

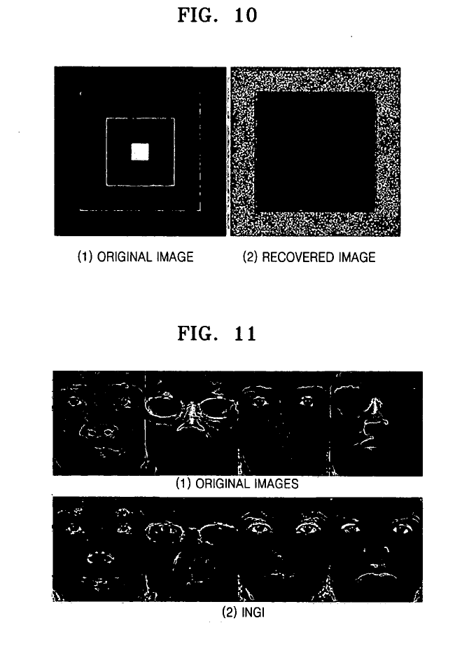

When compared to the result shown in FIG. 9, the image restored shown in FIG. 10 preserves the edge and is very stable.

The experimental results of the present invention will now be explained. In the present invention, a novel approach was tested with respect to FRGC database v1.0a and v2.0. V1.0a has 275 subjects and 7544 recordings, and v2.0 has 466 subjects and 32,056 recordings. Also, there are 3 experiments, experiments 1, 2, and 4 for 2-dimensional image recognition. The experimental results of the present invention was obtained using the same input data from the experiments 1, 2, and 4. The present invention focused on the experiment 4. The experiment 4 has a great illumination change uncontrolled indoors. In a FRGC Technical report more details on the database and experiment are described.

FIG. 11 shows the effect of illumination normalization and some samples in the experiment 4. An integral normalized gradient image (INGI) can improve face texture by restricting the illumination of the original image in highlight and shadow regions in particular. It can be seen that the shading parts sensitive to illumination are mostly removed in these images.

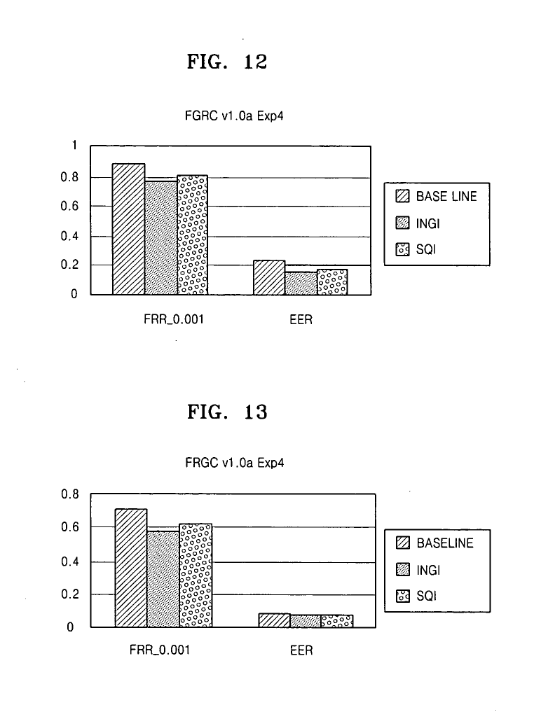

The verification experiment of the present invention does not have a preprocess, but has a simple histogram equalization process as a baseline method, and employs the original image having a nearest neighbor (NN) as a classifier. Two types of features, that is, the global (PCA) and the local (Garbor) features are used to verify generalization of the INGI. The verification rate and EER in the v1.0 are shown in FIGS. 12 and 13. The performance of the present invention is evaluated by comparing the result of SQI. The verification rate at FAR=0.01 clearly shows the improvements of both the global and local features.

In addition, though the present invention has a very similar transformation to that of the SQI method, the present invention has a little improvement over the SQI method. In order to avoid the effect of noise in the division operation in the equation 5, the present invention uses the advantage of the integral and anisotropic diffusion such that more smoothing and steady result can be obtained. Since the purpose of the present invention is to test the validity of a preprocess, only a simple NN classifier is used and the performance is not good enough when compared with the baseline result.

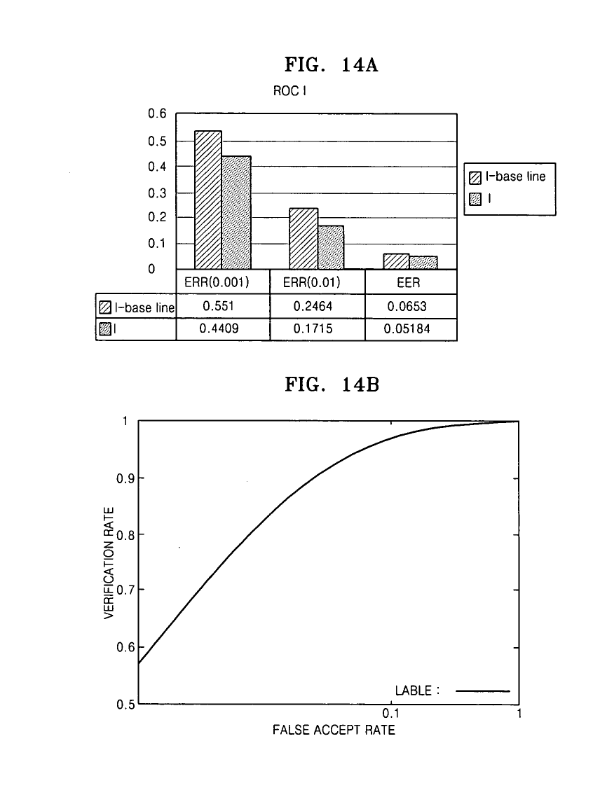

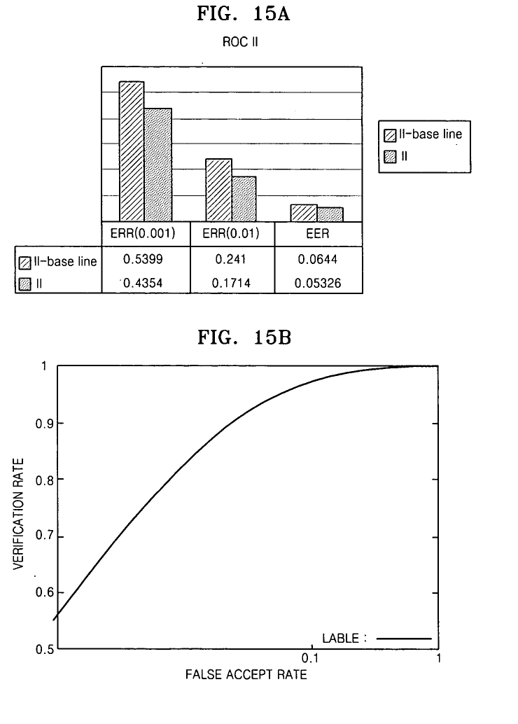

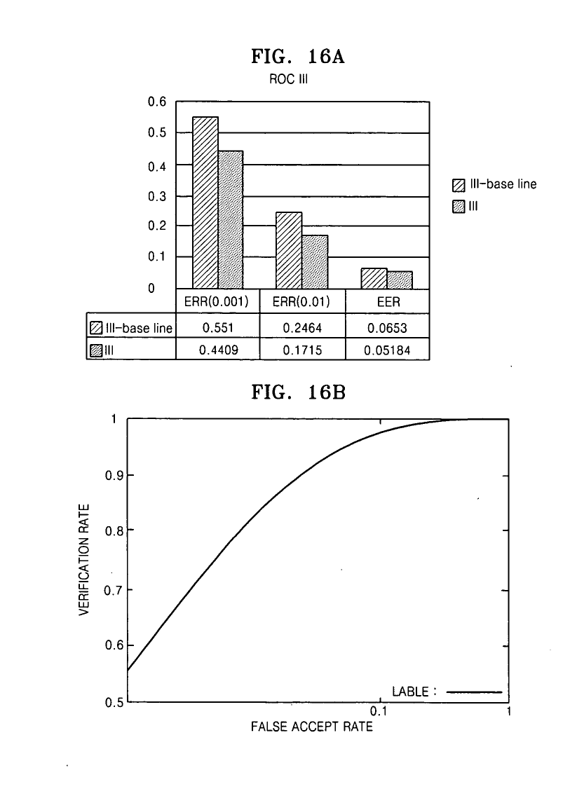

In order to examine the validity of the present invention, an experiment was performed according to an improved face descriptor feature extraction and recognition method that is a mixture of much more global and local features on a database v2.0. Since the FRGC DB is collected within a predetermined years, the v2.0 experiment 4 has 3 masks, masks I, II , and III. The masks control calculation of verifications (FRR (False Rejection Rate), FAR (False Acceptance Rate), and EER (Equal Error Rate)) in an identical semester, in an identical year, and between semesters. The verification results calculated by EER shown in FIGS. 13 through 15 indicate that the present invention improved the performances of all masks by at least 10%.

In addition to the above-described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred in/on a medium in a variety of ways, with examples of the medium including magnetic storage media (e.g., floppy disks, hard disks, magnetic tapes, etc.), optical recording media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires and metallic wires. The medium/media may also be a distributed network, so that the computer readable code/instructions is stored/transferred and executed in a distributed fashion. The computer readable code/instructions may be executed by one or more processors.

According to the method, apparatus, and medium for removing shading of an image according to the present invention, by defining a face image model analysis and intrinsic and extrinsic factors and setting up a rational assumption, an integral normalized gradient image not sensitive to illumination is provided. Also, by employing an anisotropic diffusion method, a moiré phenomenon in an edge region of an image can be avoided.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method of removing shading of an image comprising:
smoothing an input image;
performing a gradient operation for the input image;
performing normalization using the smoothed image and the images for which the gradient operation is performed; and
integrating the normalized images.

2. The method of claim 1, wherein the input image is described as a Lambertian model as the following equation:
I=ρn^{T}·s
where I denotes an input image, ρ denotes texture, n denotes a 3-dimensional shape, and s denotes illumination.

3. The method of claim 2, wherein the smoothing of the input image is performed by performing an operation of the input image and a predetermined smoothing kernel according to the following equation in relation to the shading part n^{T}·s of the equation of claim 2:
Ŵ=I*G
where Ŵ denotes a smoothed image, I denotes an input image, and G denotes a smoothing kernel.

4. The method of claim 1, wherein the gradient operation of the input image is to obtain a gradient map according to a Sobel operator.

5. The method of claim 2, wherein the gradient operation of the input image is performed according to the following equation:
∇I=∇(ρn^{T}·s)≈(∇ρ)n^{T}·s=(∇ρ)W
where W denotes a scaling factor by shading n^{T}·S.

6. The method of claim 5, wherein the normalized image is obtained by dividing the smoothed image in relation to images for which gradient operation is performed:
$$N = \frac{∇ I}{\hat{W}} \approx \frac{( ∇ ρ ) W}{\hat{W}} \approx ∇ ρ$$

7. The method of claim 1, wherein assuming that ∇_{y}I_{i,j}=I_{i,j}−I_{i-1,j} and ∇ₓI_{i,j}=I_{i,j}−I_{i,j-1}, the integrating of the normalized images is performed by the following equations:
$$\begin{matrix}{∇}_{N} I = {I}_{i - 1 , j} - {I}_{i , j} = - {∇}_{y} {I}_{i , j} \\ {∇}_{S} I = {I}_{i + 1 , j} - {I}_{i , j} = {∇}_{y} {I}_{i + 1 , j} \\ {∇}_{W} I = {I}_{i , j - 1} - {I}_{i , j} = {∇}_{x} {I}_{i , j} \\ {∇}_{E} I = {I}_{i , j + 1} - {I}_{i , j} = {∇}_{x} {I}_{i + 1 , j} \\ {I}_{i , j}^{t} = {I}_{i , j}^{t - 1} + λ [ \begin{matrix}{C}_{N} ( {I}_{i , j}^{t - 1} + {∇}_{N} I ) + {C}_{S} ( {I}_{i , j}^{t - 1} + {∇}_{S} I ) + \\ {C}_{W} ( {I}_{i , j}^{t - 1} + {∇}_{W} I ) + {C}_{E} ( {I}_{i , j}^{t - 1} + {∇}_{E} I )\end{matrix} ] \\ {C}_{K} = \frac{1}{1 + ‖ {I}_{i , j}^{t - 1} + {∇}_{K} I ‖ / G}\end{matrix}$$
where Kε{N,S,W,E}, I^{o}=0, G denotes a scaling factor, and λ denotes an updating control constant.

8. An apparatus for removing shading of an image comprising:
a smoothing unit smoothing an input image using a predetermined smoothing kernel;
a gradient operation unit performing a gradient operation for the input image using a predetermined gradient operator;
a normalization unit performing normalization using the smoothed image and the images for which the gradient operation is performed; and
an image integration unit integrating the normalized images.

9. The apparatus of claim 8, wherein the input image is described as a Lambertian model as the following equation:
I=ρn^{T}·s
where I denotes an input image, ρ denotes texture, n denotes a 3-dimensional shape, and s denotes illumination.

10. The apparatus of claim 9, wherein the smoothing of the input image is performed by performing an operation of the input image and a predetermined smoothing kernel according to the following equation in relation to the shading part n^{T}·s of the equation of claim 2:
Ŵ=I*G
where Ŵ denotes a smoothed image, I denotes an input image, and G denotes a smoothing kernel.

11. The apparatus of claim 8, wherein the gradient operation of the input image is to obtain a gradient map according to a Sobel operator.

12. The apparatus of claim 9, wherein the gradient operation of the input image is performed according to the following equation:
∇I=∇(ρn^{T}·s)≈(∇ρ)n^{T}·s=(∇ρ)W
where W denotes a scaling factor by shading n^{T}·s.

13. The apparatus of claim 12, wherein the normalized image is obtained by dividing the smoothed image in relation to images for which gradient operation is performed:
$$N = \frac{∇ I}{\hat{W}} \approx \frac{( ∇ ρ ) W}{\hat{W}} \approx ∇ ρ$$

14. The apparatus of claim 8, wherein assuming that ∇_{y}I_{i,j}=I_{i,j}−I_{i-1,j} and ∇ₓI_{i,j}=I_{i,j}−I_{i,j-1}, the integrating of the normalized images is performed by the following equations:
$$\begin{matrix}{∇}_{N} I = {I}_{i - 1 , j} - {I}_{i , j} = - {∇}_{y} {I}_{i , j} \\ {∇}_{S} I = {I}_{i + 1 , j} - {I}_{i , j} = {∇}_{y} {I}_{i + 1 , j} \\ {∇}_{W} I = {I}_{i , j - 1} - {I}_{i , j} = {∇}_{x} {I}_{i , j} \\ {∇}_{E} I = {I}_{i , j + 1} - {I}_{i , j} = {∇}_{x} {I}_{i + 1 , j} \\ {I}_{i , j}^{t} = {I}_{i , j}^{t - 1} + λ [ \begin{matrix}{C}_{N} ( {I}_{i , j}^{t - 1} + {∇}_{N} I ) + {C}_{S} ( {I}_{i , j}^{t - 1} + {∇}_{S} I ) + \\ {C}_{W} ( {I}_{i , j}^{t - 1} + {∇}_{W} I ) + {C}_{E} ( {I}_{i , j}^{t - 1} + {∇}_{E} I )\end{matrix} ] \\ {C}_{K} = \frac{1}{1 + ‖ {I}_{i , j}^{t - 1} + {∇}_{K} I ‖ / G}\end{matrix}$$
where Kε{N,S,W,E}, I^{o}=0, G denotes a scaling factor, and λ denotes an updating control constant.

15. At least one computer readable medium storing executable instructions that control at least one processor to perform the method of claim 1.

16. At least one computer readable medium storing executable instructions that control at least one processor to perform the method of claim 2.

17. At least one computer readable medium storing executable instructions that control at least one processor to perform the method of claim 3.

18. At least one computer readable medium storing executable instructions that control at least one processor to perform the method of claim 4.

19. At least one computer readable medium storing executable instructions that control at least one processor to perform the method of claim 5.

20. At least one computer readable medium storing executable instructions that control at least one processor to perform the method of claim 6.

21. At least one computer readable medium storing executable instructions that control at least one processor to perform the method of claim 7.
